(19) United States
(12) Patent Application Publication
(10) Pub. No.: US 2011/0151126 A1
(43) Pub. Date: Jun. 23, 2011

(54) TRIVALENT CHROMIUM CONVERSION COATING

(76) Inventors: Glenn A. Metts, Toledo, OH (US); Leo Jacob Filatov, Sylvania, OH (US)

(21) Appl. No.: 13/060,837

(22) PCT Filed: Aug. 31, 2009
(86) PCT No.: PCT/US09/55481

§ 371 Date: Feb. 25, 2011

Related U.S. Application Data
(60) Provisional application No. 61/092,781, filed on Aug. 29, 2008.

(51) Int. Cl. B05D 3/02; C09D 1/00; B82Y 30/00

(52) U.S. Cl. 427/372.2; 106/14.05; 977/773

(57) ABSTRACT

An aqueous composition for depositing an inorganic corrosion resistant self-healing conversion coating on a metal substrate is disclosed. The composition is substantially free from hexavalent chromium and cobalt and includes a trivalent chromium compound, a vanadate, a mineral acid, and nano-particles formed from one of carbon and silica.

### CROSS-REFERENCE TO RELATED APPLICATION

This application claims the benefit of priority of U.S. Provisional Patent Application Ser. No. 61/092,781 filed on Aug. 29, 2008.

### FIELD OF THE INVENTION

The present invention relates to a composition for forming a corrosion resistant coating. More particularly, the present invention relates to a corrosion resistant chromate coating on a metal substrate.

### BACKGROUND OF THE INVENTION

Typically, commercially available compositions for forming chromate coatings, which are also known as chromate treatment agents, include water as a solvent and contain a hexavalent chromium compound as a main ingredient, in combination with suitable proportions of a fluoride, a mineral acid, a carboxylic acid, a surfactant and other chemicals. When a work-piece, for example a zinc plated metal piece, is immersed in such a chromate treatment agent, complex compounds of trivalent and hexavalent chromiums are deposited on the surface of the work-piece to form a chromate coating.

Chromate conversion coatings (CCC) provide protection to underlying substrates and intercoat adhesion in coating systems. Chromate coatings are adapted to store and release a chromate corrosion inhibitor. The inhibitor is a chromate stored at adsorbed sites on a chemical backbone of the CCC film that are released into solution in the presence of moisture and transported to a defect site to stifle corrosion, thereby making the CCC a so-called self-healing coating. However, the corrosion inhibition attribute of the CCC may be lost as the conversion coating dehydrates under the influence of heat and/or dry environments.

To improve the corrosion characteristics of metal substrate coatings, transition metals such as manganese, cobalt, vanadium, tungsten, molybdenum, iron, and combinations of the foregoing with chromate have been used. The acceptance of manganese, cobalt, vanadium, tungsten, molybdenum, iron conversion coatings compared to CCC is largely targeted to particular metal finishing industries and no particular chromate-free coating has been as widely accepted as a CCC. Furthermore, conversion coatings including cobalt are being phased out in Europe and other regions due to mutagenic and carcinogenic side effects as a result of high levels of exposure thereto.

U.S. Pat. No. 3,501,352 issued on Mar. 17, 1970 to Vinod D. Shah discloses a composition containing a chromium chromate complex. The chromium chromate complex is prepared from aqueous chromic acid solutions which contain hexavalent chromium.

U.S. Pat. No. 3,808,057 issued on Apr. 30, 1974 to Wolfgang Lobenski, Heiny Paul Schapitz and Hans-Peter Wessel. This patent discloses a method for coating metal articles by first depositing a layer of zinc on the metal article then submerging the article in a chromic acid solution.

U.S. Pat. No. 3,857,739 issued on Dec. 31, 1974 to Michael Ward Prust and Wayne Charles Glassman and discloses a process for producing a chromium protective coating on zinc. The process utilizes chromium in the water soluble hexavalent form.

U.S. Pat. No. 3,895,969 issued on Jul. 22, 1975 to Russell C. Miller discloses a chromate depositing solution which contains hexavalent chromium.

U.S. Pat. No. 3,907,610 issued on Sep. 23, 1975 to Hidehisa Yamagishi, Hirokuni Mizuno, Yoshitaka Kashiyama and Yasuhiro Toyoda. The '610 patent discloses a process for treating metal which uses hexavalent chromium.

U.S. Pat. No. 4,126,490 issued on Nov. 21, 1978 to Aoki discloses a composition for coating the surface of a zinc metal which includes trivalent chromium, an alum, and vanadate.

U.S. Pat. No. 7,135,075 issued on Nov. 14, 2006 to Buchheit et al. discloses a composition for deposition of a self-healing coating on the surface of a metal substrate consisting essentially of a vanadate salt, soluble metal anion, and a substrate activator adapted to remove oxides on the substrate prior to formation of the coating.

Many heavy metals and elements, such as lead, mercury and arsenic for example, are dangerous when ingested or absorbed by animal tissues. These materials are environmentally undesirable and great care is taken to insure that they do not pollute the air or water. Hexavalent chromium compounds are environmentally undesirable because monochromium trioxide is deliquescent, meaning that it absorbs moisture. Monochromium trioxide absorbs water and forms undesirable chromic acid. Conversely, bivalent and trivalent chromium compounds are environmentally acceptable.

Additionally, while no country has banned the use of conversion coatings formed from compounds having nitrate [NO₃] ions, such a ban may be adopted due to the potentially undesirable effects of nitrates under certain conditions. Nitrate toxicosis, a malady that affects humans, occurs through enterohepatic metabolism of nitrates to ammonia, with a nitrite ion being an intermediate of the reaction. The nitrites oxidize the iron atoms in the hemoglobin of humans from ferrous iron (2+) to ferric iron (3+), rendering the hemoglobin unable to carry oxygen. This condition is called methemoglobinemia and can lead to a lack of oxygen in organ tissue. Infants are particularly vulnerable to methemoglobinemia due to nitrate metabolizing triglycerides present at higher concentrations during infancy than at other stages of development.

With respect to environmental concerns and nitrates, in freshwater or estuarine systems close to land, nitrate ions can reach high levels that can potentially cause the death of marine life. While nitrates are much less toxic than ammonia or nitrite, levels over 30 ppm of nitrate can inhibit growth, impair the immune system and cause stress in some aquatic species.

Another limitation common to typical conversion coatings is that the conversion coating is prepared and delivered as an aqueous solution. Environmental risks and concerns must be taken into consideration when transporting, storing, handling, and using aqueous conversion coating solutions. The bulk of the cost to transport such aqueous conversion coating solutions may be attributed to the containers (or drums) that the solution is transported in and the water weight of the solution. Once the container of conversion coating solution has been used, there are container disposal issues that must be considered. Conversion coatings prepared and transported as aqueous solutions because many of the chemical compounds combined to form the solution do not exist or are unstable in a dry or crystalline form.

It is therefore desirable to provide a chromate conversion coating which contains and produces no hexavalent chromium compound, which does not pose an environmental concern, which has improved corrosion resistant properties, and which may be transported and handled at minimized cost.

It is therefore desirable to provide a dry chromate conversion coating which contains and produces no hexavalent chromium compound, which does not pose an environmental concern, which has improved corrosion resistant properties, and which may be transported and handled at minimized cost.

### SUMMARY OF THE INVENTION

Concordant and congruous with the present invention, a chromate conversion coating which contains and produces no hexavalent chromium compound, which does not pose an environmental concern, and which has improved corrosion resistant properties has been surprisingly discovered.

In a first embodiment of the invention, a composition substantially free from hexavalent chromium and cobalt for forming a chromate coating on a substrate comprises a trivalent chromium compound with a range of about 0.5 g/L to about 5 g/L of Crₘₑₜ; a vanadate present in a range from about 0.05 g/L to about 2.5 g/L of Vₘₑₜ; a mineral acid present in a range from about 0.5 g/L to about 10 g/L; and nano-particles formed from one of carbon and silica, wherein the composition has self-healing properties.

In another embodiment, a composition substantially free from hexavalent chromium and cobalt for forming a chromate coating on a substrate comprises a trivalent chromium compound; a vanadate; a mineral acid; and nano-particles formed from one of carbon and silica, wherein the composition has self-healing properties.

In another embodiment, a method for forming a chromate coating on a substrate substantially free from hexavalent chromium and cobalt comprises providing a dry trivalent chromium compound; providing a dry vanadium based compound; mixing the dry trivalent chromium compound and the dry vanadium based compound; and adding a desired amount of water to the mixed dry trivalent chromium compound and the dry vanadium based compound to form a solution; applying the solution on a substrate; and drying the composition coated substrate to form a chromate coating having self-healing properties.

Further objects and advantages of the invention will be apparent from the following description and appended claims.

### DETAILED DESCRIPTION OF THE PREFERRED EMBODIMENT

The following detailed description describes various exemplary embodiments of the invention. The description serves to enable one skilled in the art to make and use the invention, and are not intended to limit the scope of the invention in any manner. In respect of the methods disclosed, the steps presented are exemplary in nature, and thus, the order of the steps is not necessary or critical.

A composition substantially free from hexavalent chromium and cobalt for forming a solution for forming a chromate coating on a substrate comprises a dry trivalent chromium based compound, wherein the dry trivalent chromium based compound is water soluble; and a dry vanadium based compound, wherein the dry vanadium based compound is water soluble.

A soluble vanadate is also present in the composition in an amount from about 0.05 g/L to about 2.5 g/L of Vₘₑₜ. It is understood that any desired amount of vanadate may be used in the composition, as desired. Any soluble vanadate may be used such as metavanadates, pyrovanadates, orthovandates, for example. The use of potassium metavanadate in the composition has produced a chromate coating having favorable corrosion results in some laboratory tests.

The composition may also include a mineral acid from about 0.5 g/L to about 10 g/L to provide additional corrosion resistance to the chromate coating. Furthermore, the composition may include nano-particles adapted to enhance the corrosion resistance of the composition. The nano-particles may include silica-based particles or carbon-based particles sized between about 1 and about 2500 nanometers. It is understood that the composition is substantially cobalt free to minimize the mutagenic and carcinogenic side effects caused thereby.

To form the chromate conversion coating, a substrate formed from zinc, a zinc alloy, cadmium, aluminum, magnesium, and iron, for example, is immersed in the aqueous composition described herein for about 30 seconds to about 150 seconds. The composition typically has a pH range from about 1.0 to about 5.0 and is at a temperature from about 17° C. to about 35° C. Coatings with useful corrosion resistance properties may form on the substrate in a matter of seconds, but coatings with preferred corrosion resistance properties in electrochemical testing generally from in about 0.5 minutes to about 3 minutes. For substrates too large for immersion, the composition may be applied by brush plating, rolling, spraying, or another conventional method of applying the aqueous composition on the substrate.

It is understood that prior to forming the coating on the substrate, the substrate may be washed with an alkaline detergent, degreased in a sodium silicate/sodium carbonate solution, and deoxidized in a nitric acid/sodium bromate-based solution. The substrate may be rinsed in deionized water between any washing steps. The substrate may also be treated with an accelerator and/or an activator prior to immersion in or application of the aqueous composition.

On the substrate, the aqueous composition has a gelatinous consistency. The gelatinous composition is allowed to dry in ambient air for about 24 to 48 hours to form the functional coating. It is understood that the gelatinous composition may be dried in a dryer, with a fan, or with another mechanical means, as desired. The chromate coating may be less than 300 nanometers thick (a thin coating) or more than 300 nanometers thick (a thick coating), as desired. The chromate coating formed from the composition deposited on the substrate includes trivalent chromium compounds and contains no hexavalent chromium compound. Depending on the formulation of the compound, the coating may have a black or yellow color or may be clear, as desired. It is understood that the corrosion resistance of the coating may vary from color to color.

The chromate coating also has self-healing properties to provide additional corrosion protection to the substrate. The coating is self-healing because the components of the composition are adapted to release an inhibitor into an attacking electrolyte to self-heal minor amounts of mechanical or chemical damage in the chromate coating on the substrate. In self-healing, chromates stored at adsorbed sites are released into solution where they may be transported to defect sites to stifle further corrosion due to mechanical or chemical damage. Furthermore, the components of the composition are adapted to react with moisture in the ambient air to self-heal minor amounts of mechanical or chemical damage.

A substrate having a chromate coating prepared as described herein was subjected to a continuous salt spray testing in accordance with ASTM B117-07 for a period of 120 hours. After 120 hours, the sample showed 0% white or red corrosion indicating a desired corrosion resistance.

In another embodiment, a composition according to the invention contains from about 0.5 g/L to about 5.0 g/L of a trivalent chromium metal typically provided by a trivalent chromium based compound. However, it is understood that any amount of trivalent chromium compound may be used in the composition, as desired. The trivalent chromium based compound is provided in a dry form, rather than in a solution. Typical trivalent chromium compounds used to form the composition include chromium chloride, chromium sulfate, chromium hydroxide, chromium potassium sulfate, and a combination of the foregoing. The use of a dry chromium potassium sulfate in the composition has produced a chromate coating having favorable corrosion results in some laboratory tests.

A water-soluble vanadium based compound is also present in the composition in an amount from about 0.05 g/L to about 2.5 g/L of vanadium metal. It is understood that any desired amount of vanadate may be used in the composition, as desired. The vanadium based compound is provided in a dry form, rather than in a solution. Any soluble vanadate may be used such as metavanadates, pyrovanadates, orthovandates, for example. Specifically, the vanadium metal may be obtained from a vanadium oxide, ammonium vanadate, sodium vanadate, potassium vanadate, and a combination of the foregoing, as desired. The use of a dry potassium vanadate, a stable compound that is soluble in water, in the composition has produced a chromate coating having favorable corrosion results in some laboratory tests.

It is understood that the composition may also include mineral acids in an amount from about 0.5 g/L to about 10 g/L to provide additional corrosion resistance to the chromate coating. Furthermore, the composition may include nano-particles adapted to enhance the corrosion resistance of the composition. The nano-particles may include silica-based particles or carbon-based particles sized between about 1 and about 2500 nanometers.

The composition is substantially hexavalent chromium free, substantially cobalt free, and substantially nitrate free in order to minimize environmental and health effects caused thereby. As used here, “substantially free” means less than about 500 ppm. It is understood that trace amounts of nitrates may be found in the composition, so long as the trace amount is less than 500 ppm; for example the composition may have less than 400 ppm, less than 300 ppm, less than 200 ppm, less than 100 ppm, or less than 10 ppm, as desired. It may be desirable to have a composition with about 0 ppm nitrates, as desired.

To form the chromate conversion coating, the dry trivalent chromium based compound and the dry vanadium based compound are mixed together and transported to an end user. Due to the absence of water, the packaging volume and weight of the mixed compound is minimized, as is the cost of transporting the compound. Furthermore, concerns with respect to handling the compound and disposal of the shipping container are minimized due to the absence of water from the compound. Once the end user obtains the dry compound, water is added to the dry compound in a desired amount to obtain an aqueous composition having from about 0.5 g/L to about 5.0 g/L of trivalent chromium metal and from about 0.05 g/L to about 2.5 g/L of vanadium metal. The aqueous composition is substantially free from cobalt and substantially free from nitrates, and has a pH range from about 1.0 to about 5.0 and is at a temperature from about 17° C. to about 35° C.

A substrate formed from zinc, a zinc alloy, cadmium, aluminum, magnesium, and iron, for example, is then immersed in the aqueous composition described herein for about 30 seconds to about 150 seconds. Coatings with useful corrosion resistance properties may form on the substrate in a matter of seconds, but coatings with preferred corrosion resistance properties in electrochemical testing generally from in about 0.5 minutes to about 3 minutes. For substrates too large for immersion, the composition may be applied by brush plating, rolling, spraying, or another conventional method of applying the aqueous composition on the substrate.

It is understood that prior to forming the coating on the substrate, the substrate may be washed with an alkaline detergent, degreased in a sodium silicate/sodium carbonate solution, and deoxidized in a nitric acid/sodium bromate-based solution. The substrate may be rinsed in deionized water between any washing steps. The substrate may also be treated with an accelerator and/or an activator prior to immersion in or application of the aqueous composition.

On the substrate, the aqueous composition has a gelatinous consistency. The gelatinous composition is allowed to dry in ambient air for about 24 to 48 hours to form the functional conversion coating. It is understood that the gelatinous composition may be dried in a dryer, with a fan, or with another mechanical means, as desired. The chromate coating may be less than 300 nanometers thick (a thin coating) or more than 300 nanometers thick (a thick coating), as desired. The chromate coating formed from the composition deposited on the substrate includes trivalent chromium compounds and contains no hexavalent chromium compound. Depending on the formulation of the compound, the coating may have a black or yellow color or may be clear, as desired. It is understood that the corrosion resistance of the coating may vary from color to color.

The chromate coating also has self-healing properties to provide additional corrosion protection to the substrate. The coating is self-healing because the components of the composition are adapted to release an inhibitor into an attacking electrolyte to self-heal minor amounts of mechanical or chemical damage in the chromate coating on the substrate. In self-healing, chromates stored at adsorbed sites are released into solution where they may be transported to defect sites to stifle further corrosion due to mechanical or chemical damage. Furthermore, the components of the composition are adapted to react with moisture in the ambient air to self-heal minor amounts of mechanical or chemical damage.

A substrate having a chromate coating prepared as described herein was subjected to a continuous salt spray testing in accordance with ASTM B117-07 for a period of 120 hours. After 120 hours, the sample showed 0% white or red corrosion indicating a desired corrosion resistance.

In accordance with the provisions of the patent statutes, the present invention has been described in what is considered to represent its preferred embodiment. However, it should be understood that the invention can be practiced otherwise than as specifically illustrated and described without departing from its spirit or scope.

What is claimed is:

1. A composition substantially free from hexavalent chromium and cobalt for forming a solution for forming a chromate coating on a substrate comprising:
a dry trivalent chromium based compound, wherein the dry trivalent chromium based compound is water soluble; and
a dry vanadium based compound, wherein the dry vanadium based compound is water soluble.

2. The composition of claim 1, wherein the dry trivalent chromium based compound is one of a chromium chloride, chromium sulfate, chromium hydroxide, chromium potassium sulfate, and a combination of the foregoing.

3. The composition of claim 2, wherein the dry trivalent chromium based compound is a dry chromium potassium sulfate.

4. The composition of claim 1, wherein the dry trivalent chromium compound is present in the solution in a range of about 0.5 g/L to about 5 g/L of Crₘₑₜ.

5. The composition of claim 1, wherein the dry vanadium based compound is one of a dry metavanadate, pyrovanadate, and orthovandates.

6. The composition of claim 5, wherein the dry vanadium based compound is a vanadium oxide, ammonium vanadate, sodium vanadate, potassium vanadate, and a combination of the foregoing.

7. The composition of claim 6, wherein the dry vanadium based compound is a dry potassium vanadate.

8. The composition of claim 1, wherein the dry vanadate based compound is present in the solution in a range of about 0.05 g/L to about 2.5 g/L of Vₘₑₜ.

9. The composition of claim 1, wherein the composition is substantially free from nitrates.

10. The composition of claim 1, further comprising a mineral acid.

11. The composition of claim 10, wherein the mineral acid is present in the solution in a range from about 0.5 g/L to about 10 g/L.

12. The composition of claim 1, further comprising nano-particles formed from one of carbon and silica.

13. A composition substantially free from hexavalent chromium and cobalt for forming a chromate coating on a substrate comprising:
a trivalent chromium compound;
a vanadate;
a mineral acid; and
nano-particles formed from one of carbon or silica, wherein the composition has self-healing properties.

14. The composition of claim 13, wherein the composition is substantially free from nitrates.

15. The composition of claim 13, wherein the trivalent chromium compound is present in a range from about 0.5 g/L to about 5 g/L of Crₘₑₜ.

16. The composition of claim 13, wherein the vanadate is present in a range from about 0.05 g/L and 2.5 g/L of Vₘₑₜ.

17. The composition of claim 13, wherein the mineral acid is present in a range from about 0.5 g/L and 10.0 g/L.

18. The composition of claim 13, wherein the trivalent chromium compound is one of chromium nitrate, chromium chloride, chromium sulfate, chromium hydroxide, chromium potassium sulfate, and a combination of the foregoing.

19. The composition of claim 18, wherein the vanadate is a water soluble vanadate selected from the group consisting essentially of a metavanadate, a pyrovanadate, and an orthovandate.

20. A method for forming a chromate coating on a substrate substantially free from hexavalent chromium and cobalt comprising:
providing a dry trivalent chromium compound;
providing a dry vanadium based compound;
mixing the dry trivalent chromium compound and the dry vanadium based compound; and
adding a desired amount of water to the mixed dry trivalent chromium compound and the dry vanadium based compound to form a solution;
applying the solution on a substrate; and
drying the composition coated substrate to form a chromate coating having self-healing properties.
